(19) United States
(12) Patent Application Publication
(10) Pub. No.: US 2026/0225804 A1
(43) Pub. Date: Aug. 6, 2026

(54) AN AUTOMATIC SHUTTLE WITH TILTABLE REST PLANE

(71) Applicant: SYSTEM LOGISTICS S.P.A., FIORANO MODENESE (MODENA) (IT)

(72) Inventor: MASSIMILIANO CAMBONI, MODENA (IT)

(21) Appl. No.: 19/102,549

(22) PCT Filed: Jun. 14, 2023
(86) PCT No.: PCT/IB2023/056134

§ 371 Date: Feb. 10, 2025

(30) Foreign Application Priority Data
Jul. 27, 2022 (IT) 102022000015828

(51) Int. Cl. B65G 1/04; B65G 1/06; B65G 1/137

(52) U.S. Cl. CPC B65G 1/0492; B65G 1/0485; B65G 1/06; B65G 1/1371

(57) ABSTRACT

Automatic shuttle that includes a self-propelled unit configured to displace along a set trajectory on a displacement surface; a rest plane, associated with an upper portion of the self-propelled unit and accessible to enable an object arranged on the rest plane to be removed, and to enable an object to be deposited; characterized in that the rest plane is rotatable around a rotation axis (X) between at least one first position, in which it substantially lies on a horizontal plane, and at least one second position, in which it lies on a plane tilted relative to the horizontal plane.

The object of the present invention is an automatic shuttle with a tiltable rest plane. The invention also relates to an automatic warehouse comprising said automatic shuttle.

The name “automatic warehouse” means a storage plant that is widely known and widespread in many different sectors, which essentially comprises a certain number of shelvings, each of which is provided with a certain number of floors that are superimposed on one another. The shelvings are intended to support various objects, typically in the form of boxes containing other products. The shelvings are arranged in an orderly manner, so as to limit a set number of separating corridors along which transport vehicles are movable, typically of AGV or LGV type. Many various handling systems that are known in the sector are used to transfer objects between the transport vehicles and the shelvings. These handling systems are substantially set up to be able to transfer one or more objects from a shelving to a transport vehicle and/or to transfer one or more objects from a transport vehicle to shelving. The handling systems can be provided with elevators to enable the shelves to be serviced that are arranged at different heights.

The automatic warehouses are managed by a control system that, extremely concisely, contains the data on the position and on the content of each object positioned on one of the shelves of the shelvings. In particular, the shelves of all the shelvings comprise a certain number of operating spaces that are suitable for receiving an object. The control system contains the data on the positions of all the operating spaces. The control system is further set up to guide the transport vehicles inside the plant and to drive the handling systems.

Very briefly, the control system is able to manage requests to pick up one or more objects contained inside the warehouse, and requests to deposit or relocate one or more objects inside the warehouse.

In a manner known in the sector, the control system responds to a request to pick up a determined object contained in the warehouse by guiding a transport vehicle at the operating space in which the object is contained by activating the handling systems so as to transfer the object from the operating space thereof to the transport vehicle and, subsequently, by guiding the vehicle to an inlet/outlet station, set up to transfer the object from the vehicle to a pickup position at which the selected object can be picked up by an operator or by another device.

A request to deposit an object inside the warehouse occurs substantially with a cycle of operations that is the reverse with respect to the cycle summarised above.

In current automatic warehouses, the inlet/outlet stations consist of relatively complex and bulky devices, which comprise roller conveyors and/or conveyor belts that are variously arranged, loading/unloading systems and other components.

In addition to the cost and to the operational complexity, the inlet/outlet stations occupy relatively extended spaces, significantly reducing the capacity of the automatic warehouse.

The object of the present invention is to solve the drawbacks summarized above, enabling the complexity and the cost of current automatic warehouses to be reduced and, in parallel, increasing the capacity thereof. The main advantage offered by the present invention is that it enables the inlet and outlet stations to be eliminated that are currently in use in automatic warehouses.

Additional features and advantages of the present invention will become more apparent from the following detailed description of an embodiment of the invention in question, illustrated by way of non-limiting example in the appended figures, in which:

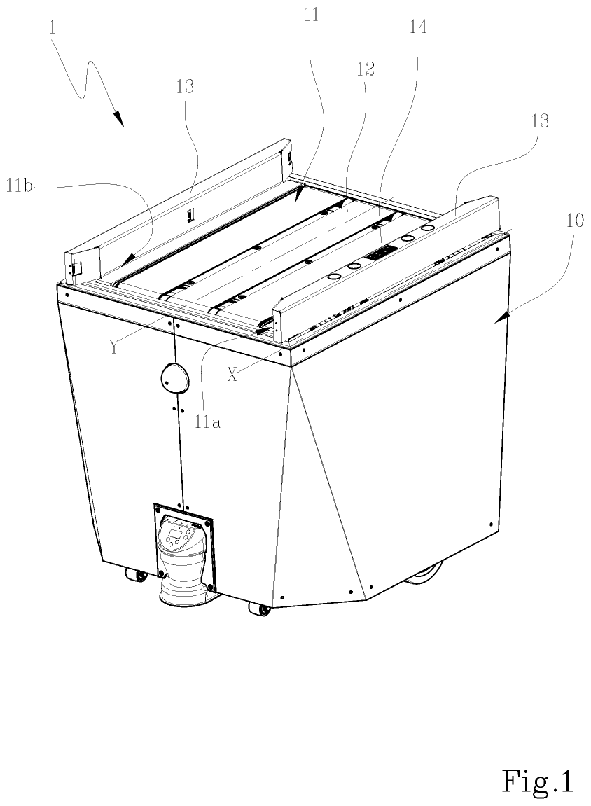

FIG. 1 shows an isometric view of an automatic shuttle according to the present invention, in a first operating configuration;

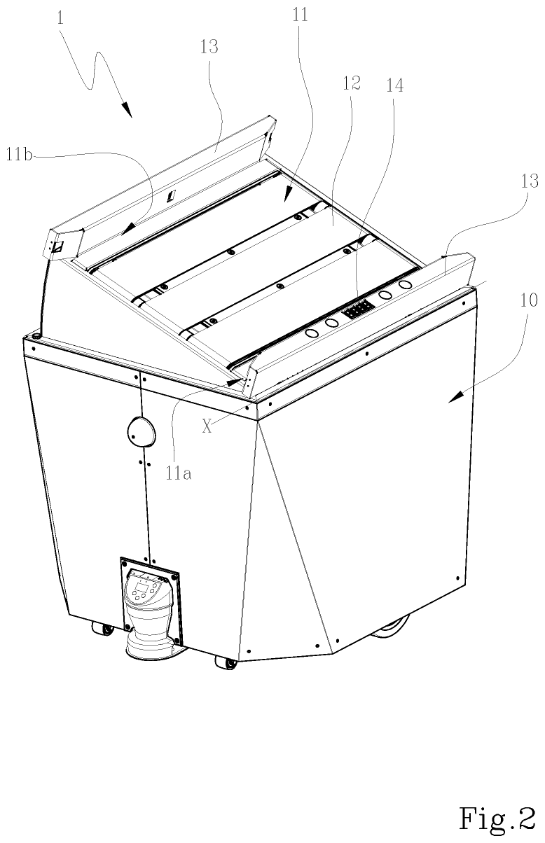

FIG. 2 shows an isometric view of the automatic shuttle of FIG. 1 in a second operating configuration;

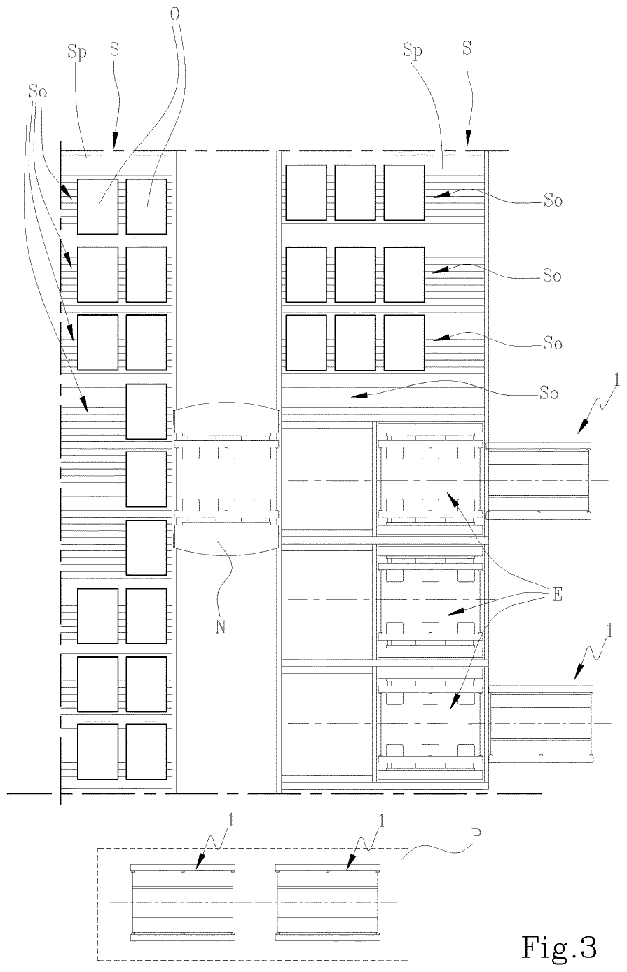

FIG. 3 shows a schematic plan view of an automatic warehouse according to the present invention.

The automatic shuttle according to the present invention comprises a self-propelled unit (10), configured to displace along a set trajectory on a movement surface.

Overall, the self-propelled unit (10) is known to the expert person and is not shown in detail. The self-propelled unit (10) comprises a load-bearing frame with which wheels are associated that are intended to rest on the ground. The self-propelled unit (10) further comprises a steering device that can be made in different configurations that are known in the sector. At least one of the wheels is connected to a motor directly or by a transmission. The self-propelled unit (10) is further provided with an autonomous guiding system, i.e. a system configured to control at least the motor and the steering device, in order to take the self-propelled unit (10) along a set trajectory. The autonomous guiding system is connected, preferably by means of the transmission of wireless data, to a control system, which will be described better below. In a manner known in the sector, the self-propelled unit (10) is provided with one or more safety sensors, which are set up to detect the presence of obstacles along the trajectory of the self-propelled unit (10) and to send a corresponding signal to the autonomous guiding system and/or to the main control module so that an emergency manoeuvre is actuated that stops and/or deviates the displacement of the self-propelled unit (10).

The shuttle according to the present invention is further provided with a rest plane (11), associated with an upper portion of the self-propelled unit (10). The rest plane (11) is accessible to enable an object to be picked up that was previously arranged on the rest plane (11) itself or to enable an object to be deposited. In other terms, the rest plane (11) is accessible from the exterior so that it is possible to pick up objects supported on it or to deposit objects there. In particular, the rest plane (11) is accessible from above, i.e. from a zone above the shuttle.

Advantageously, the rest plane (11) is rotatable around a rotation axis (X) between at least one first position, in which it substantially lies on a horizontal plane, and at least one second position, in which it lies on a plane tilted relative to the horizontal plane.

In the first position of the rest plane (11), the objects deposited on the rest plane (11) rest on a substantially horizontal plane and are thus in a stable position that is particularly suitable for the transport phases during displacements of the shuttle.

In the second position of the rest plane (11), the objects deposited on the rest plane (11) are tilted in a manner concordant with the tilt assumed by the rest plane (11). This tilt favours the access to an upper zone of the objects deposited on the rest plane (11) by for example an operator who is standing next to the shuttle. In particular, if the object deposited on the rest plane (11) is a box open at the top, the second position of the rest plane (11) enables to tilt, that is to direct, the upper opening of the box towards a side of the rest plane corresponding to the tilt angle assumed by the rest plane (11). In such conditions, an operator, by standing on the side that the rest plane (11) faces, or on the side that the upper opening of the box faces, obtains a better view and better accessibility inside the box, as to be able to pick up or deposit objects inside the box in a particularly easy manner.

In the preferred but non-exclusive embodiment shown, the rotation axis (X) is arranged near an edge of the rest plane (11). The rest plane (11) is rotated in such a direction that in the second position the zone of the rest plane (11) that is further from the rotation axis (X) lifts up relative to the height assumed in the first position. The zone of the edge and the edge that are near the rotation axis (X) on the other hand remain substantially at the same height in the first and in the second position of the rotation axis (11).

In the preferred but not exclusive embodiment shown, the rest plane (11) has a first edge (11a) that is substantially rectilinear and horizontal. The rotation axis (X) is parallel and near this first edge (11a). In this manner, in the rotation from the first to the second position, the zone of the rest plane (11) that is further from the first edge (11a) relative to the zone near the first edge (11a) and the rest plane (11) assumes a tilt declining towards the first edge (11a). In particular, the rest plane (11) has a second edge (11b) parallel to the first edge (11a). In the second position of the rest plane (11), the second edge (11b) is lifted relative to the first edge (11a), so that the rest plane (11) assumes a tilt that is declining from the second edge (11b) to the first edge (11a).

Preferably, but not necessarily, the rest plane (11) has a substantially rectangular outline. Preferably, the rotation axis (X) is substantially horizontal.

In the preferred but non-exclusive embodiment shown, the rest plane (11) comprises motor means (12), configured to translate an object along an operating direction (Y). Preferably, said operating direction (Y) is substantially horizontal. Preferably, the operating direction (Y) is parallel to the first and to the second edge (11a, 11b) of the rest plane (11). Preferably, said operating direction (Y) is substantially parallel to said rotation axis (X). For example, the motor means (12) comprises a movable belt means, as in the embodiment shown. In particular, the motor means comprises one or more movable belts wound around a pair of rollers, of which at least one is motorised, so as to be arranged according to a closed-loop path. An upper portion of the path is substantially rectilinear and lies on the rest plane (11). This solution is well known in the sector, together with other equivalent solutions that are within the reach of the expert person.

The motor means performs the function of loading or unloading the objects from the rest plane (11). In particular, the motor means is configured, in a known manner, to interact with handling means with which an automatic warehouse is normally provided. This handling means will be disclosed better below.

Preferably, but not necessarily, the rest plane (11) comprises one or two sides (13), set up to contain the displacements of an object arranged on the rest plane (11). Preferably, the sides (13) are configured so as to contain the displacements along a direction parallel to the rest plane (11) and perpendicular to the rotation axis (X). In the preferred but non-exclusive embodiment shown, the sides (13) are configured to contain the displacements on the rest plane (11) directed perpendicularly to the operating direction (Y) of the motor means (12). In particular, each side (13) is arranged along a respective edge (11a, 11b) of the rest plane (11). Each side substantially comprises a vertical wall that rises perpendicularly above the rest plane (11) for a preset height.

Advantageously, the shuttle according to the present invention comprises a display (14) set up to show significant information on an object arranged on the rest plane (11). For example, the display (14) is located along the first edge (11a) of the rest plane (11), so as to remain substantially at the same height, just like the first edge (11a), in the first and in the second position of the rest plane (11). Further, the display (14) is arranged on a plane substantially parallel to the rest plane (11), so as to tilt parallel to the rest plane (11) in the second position and facilitate visibility to an operator.

For example, the display (14) can be used to show information identifying an object arranged on the rest plane (11). In the case of objects contained inside a box, the display (14) can be used to indicate the number of objects present on the rest plane (11) inside the box, and/or to indicate a number of objects to be picked up from or deposited inside the box on the rest plane (11). For this purpose, the rest plane (11) can be provided with a weighing device, known in the sector, to count the number of objects present on the rest plane (11), if the weight of the box and the weight of a single object are known. This obviously applies in the presence of objects that are the same as one another.

As already mentioned, the shuttle according to the present invention is particularly useful and advantageous in an automatic warehouse. FIG. 3 shows an example of a possible configuration of at least one portion of an automatic warehouse, seen in a plan view or seen from above.

In the embodiment shown, there is illustrated an example of an automatic warehouse, or of a zone of an automatic warehouse that can be replicated and/or amplified as a function of the layout and of the overall capacity of the warehouse.

The automatic warehouse comprises one or more shelvings(S) each of which comprises one or more vertically superimposed shelves (Sp). In FIG. 3, only the shelves that are arranged at the upper height of the respective shelvings(S) are visible. Each shelf comprises one or more operating spaces (So), configured to house at least one object (O).

The automatic warehouse further comprises handling means (H), structured to transfer one or more objects from an operating space (So) to a shuttle (1) according to the present invention.

This handling means, which is known in the sector in various embodiments, comprises for example one or more elevators (E) that are vertically movable through the shelves (Sp) of the shelvings(S). In FIG. 3, which represents a top view of the automatic warehouse, the elevators (E) are visible through respective guide structures that extend vertically, i.e. along a direction perpendicular to the plane of the view of FIG. 3. Such guide structures, which are well known in the sector, extend through the shelves (Sp) of the relative shelving(S).

Each elevator (E) is provided with gripping means for loading on board one or more objects and for pushing said one or more objects to a shuttle (1). The handling means can further comprise one or more vehicles (N), which are in turn provided with gripping means to load on board one or more objects and to push said one or more objects to a shuttle (1) and/or to said elevators (E) and/or to other exchange stations that are not illustrated. The vehicles (N) could be of the stacker crane type, or each vehicle (N) could be connected to a level of shelves (Sp), or each vehicle (N) is set up to interact with the objects (O) present on a set level of shelves (Sp).

In the embodiment shown, solely by way of example, at least some elevators (E) are set up to push the objects (O) to the shuttles (1) present in the warehouse. In a manner known in the sector, the objects (O) can be transferred from one shelving to the other by a combination of displacements covered by using the vehicles (N) and the elevators (E). Each elevator (E) is able to take the objects (E) to an exchange position, a height or level suitable for transferring on a shuttle (1) that is movable at the level of the ground.

The warehouse according to the present invention further comprises a control system.

In a manner known in the sector, the control module mentioned in the present description and in the following claims is generically referred to as a single unit, but can in fact be provided with distinct functional modules (memory modules or operating modules), each responsible for controlling a given device or cycle of operations.

In substance, the control module can consist of a single electronic device, programmed to carry out the functions described, and the various functional modules can correspond to hardware and/or routine software entities which are part of the programmed device. Alternatively, or additionally, such functions can be performed by a plurality of electronic devices over which the aforesaid functional modules can be distributed.

The units can further rely on one or more processors for the execution of the instructions contained in the memory modules. Further, the units and the aforesaid functional modules can be distributed over different local or remote calculators on the basis of the architecture of the network in which they reside.

In a known manner, the control system contains data relating to at least the following information:
position of each operating space (So);
position of said handling means (E,N);
each object (O) located in one of the operating spaces;
position of each shuttle (1).

The control system is configured to guide each shuttle (N) along a set path, to reach one or more exchange positions, and to drive said handling means (E,N) so as to carry or pick up one or more preset objects (O) at at least one of said exchange positions. In particular, the control system dialogues with the autonomous guiding system with which each shuttle is provided.

If one or more objects (O) are picked up, the handling means (E,N) takes one or more preset objects (O) to at least one of said exchange positions, from which the objects (O) are loaded by a shuttle (1). If one or more objects are deposited, a shuttle (1) takes the objects (O) to an exchange position, from which the objects (O) are loaded by the handling means (E,N).

To sum up, according to methods known in the sector, the control module is constantly updated, in real time, on the position of all the objects (O) present on the shelves of the various shelvings(S). In particular, the control system knows the position of all the operating spaces (So) and the type of object located in each operating space (So). The control system further knows the position of all the exchange positions present as well as the positions of all the shuttles (1) present and the loading/unloading status of each shuttle (1). The control system also knows the position of all the handling means (E,N), as well as the loading/unloading status of each handling means.

The control system is set up to receive requests to pick up or deposit a given object (O) inside the automatic warehouse.

In the event of a pickup request, the control system, by algorithms of known type, activates the handling means (E,N), coordinating the displacements thereof so that the requested object is taken to an exchange position. For example, in the embodiment shown, the final portion of the path, as far as the exchange position, is covered by means of an elevator (E). The control system further guides at least one shuttle (1) to the pre-chosen exchange position so that the latter can receive the object (O). As already said, the rest plane (11) of the shuttle (1) is in the first position to receive the object (O). At least the final displacement that takes the object (O) to the rest plane (11) can be achieved by the motor means (12) with which the rest plane (11) is equipped.

Once the requested object or objects (O) has/have been loaded, the control system guides the shuttle (1) to a pickup/deposit area (P). In the event of a pickup request, at this pickup/deposit area (P) it is possible to interact with the object (O) that is arranged on the rest plane of the shuttle (1), to pick up the object (O) or if the object (O) is a box containing objects, it is possible to remove a set quantity of said objects. In order to facilitate pickup operations, the control system activates the rest plane (11) in the second position, according to the already disclosed methods. When the pickup operations have finished, the control system guides the shuttle (1) to the preceding exchange position or to another destination. If the pickup concerned a certain number of objects contained inside a box, this box can be returned to the operating space (So) of origin by the handling means (E,N).

In the case of a deposit request, the control system commands a cycle of operations that is almost the reverse of the cycle of operations summarized before. In practice, the control system guides a shuttle (1) to a pickup/deposit area (P). At this pickup/deposit area (P), it is possible to arrange an object (O) on the rest plane (11) of the shuttle (1). In the event of objects intended to be placed in a box, the control system acts in such a manner as to take the intended box to the pickup/deposit area, in the methods described above for a pickup request. In order to facilitate the depositing operations, the control system activates the rest plane (11) in the second position. When the pickup operations have finished, the control system guides the shuttle (1) to a set exchange position at which the handling means (E,N), activated by the control system, picks up the object (O) and takes the object (O) to a set operating position (So).

In the automatic warehouse according to the present invention, picking up and depositing objects inside the warehouse are possible directly on any one of the shuttles (1) present, guided by the control system to the pickup depositing area (P).

In current automatic warehouses on the other hand, picking up and depositing occur at bulky inlet/outlet stations that consist of relatively complex and costly devices, comprising roller conveyors and/or conveyor belts that are variously arranged, loading/unloading systems and other components. In addition to the cost and to the operational complexity, the inlet/outlet stations occupy relatively extended spaces, significantly reducing the capacity of the automatic warehouse.

Using the shuttles (1) according to the present invention thus enables the inlet/outlet stations to be eliminated that are currently present in the automatic warehouses. This permits significant cost and space savings that can be used to increase the capacity of the warehouse or for other operational needs. Further, thanks to the independent mobility, controlled by the control system, the pickup/deposit area (P) can be located substantially in any position, significantly increasing the flexibility of use and of management of the automatic warehouse.

1. An automatic shuttle comprising: a self-propelled unit (10) configured to displace along a set trajectory on a movement surface; a rest plane (11), associated with an upper portion of the self-propelled unit (10) and accessible to enable an object deposited on the rest plane (11) to be picked up and to enable an object to be deposited; wherein the rest plane (11) is rotatable around a rotation axis (X) between at least one first position, in which it substantially lies on a horizontal plane, and at least one second position, in which it lies on a plane tilted relative to the horizontal plane.

2. The shuttle according to claim 1, wherein said rotation axis (X) is arranged near an edge of the rest plane (11).

3. The shuttle according to claim 1, wherein said rotation axis (A) is substantially horizontal.

4. The shuttle according to claim 1, wherein the rest plane (11) comprises motor means (12), configured to translate an object along an operating direction (Y).

5. The shuttle according to claim 4, wherein said operating direction (Y) is substantially horizontal.

6. The shuttle according to claim 4, wherein said operating direction (Y) is substantially parallel to said rotation axis (X).

7. The shuttle according to claim 1, wherein the rest plane (11) comprises one or two sides (13), arranged to contain the displacements of an object on the rest plane (11), along a direction parallel to the rest plane (11) and perpendicular to the rotation axis (X).

8. The shuttle according claims claim 1, comprising a display (14) arranged to show significant information on an object arranged on the rest plane (11).

9. An automatic warehouse, comprising:
one or more shelvings(S) each of which comprises one or more vertically superimposed shelves (Sp), in which each shelf comprises one or more operating spaces (So), configured to house at least one object (O), and at least one exchange position;
one or more transport vehicles (1);
handling means (E,N), structured to displace an object between an operating space (So) to at least one exchange position, and to displace an object (O) between said exchange position and a transport vehicle (1);
a control system that contains data relating to at least the following information:
position of each operating space (So);
position of each transport vehicle (1);
position of said handling means (E,N);
each object (O) located in one of the operating spaces;
wherein the control system is configured to:
guide each transport vehicle (1);
operate said handling means (E,N);
wherein:
at least one of said transport vehicles is an automatic shuttle (1) according to claim 1;
the control system is configured to guide each transport vehicle (1) along a set path between at least one of said exchange positions and a pickup/deposit area (P), at which it is possible to pick up or deposit an object on the rest plane (11).

10. A method for picking up an object (O) from an automatic warehouse, wherein the automatic warehouse comprises:
one or more shelvings(S) each of which comprises one or more vertically superimposed shelves (Sp), in which each shelf comprises one or more operating spaces (So), configured to house at least one object (O), and at least one exchange position;
one or more automatic shuttles (1) according to claim 1;
handling means (E,N), structured to displace an object between an operating space (So) to at least one exchange position, and to displace an object (O) between said exchange position and a transport vehicle (1);
the method comprising the following steps:
activating said handling means (E,N) to transfer the object (O) from the respective operating space (So) to an exchange position;
guiding at least one automatic shuttle (1) near said exchange position;
transferring the object (O) from the exchange position to the rest plane (11) of the automatic shuttle (1);
guiding the automatic shuttle (1) from said exchange position to a pickup/deposit area (P);
picking up the object (O), or an item contained inside the object (O).

11. The method according to claim 10, wherein: in the step of transferring the object (O) from the exchange position to the rest plane (11) of the automatic shuttle (1), the rest plane (11) is in the first position; the rest plane (11) is taken to the second position when the automatic shuttle (1) reaches the pickup/deposit area (P).

12. The method according to claim 10, wherein the automatic warehouse comprises a control system, arranged to guide each automatic shuttle (1) along a set path and to operate said handling means (E,N), which contains data on at least the following information:
position of each operating space (So);
position of each transport vehicle (1);
position of said handling means (E,N);
each object (O) located in one of the operating spaces;
the method comprising the following steps:
sending to the control system a request to pick up a pre-chosen object, such that the control system activates the handling means (E,N) and at least one shuttle (1) to transfer the pre-chosen object from the respective operating space (So) to said pickup/deposit area (P).
